(19) United States
(12) Patent Application Publication
(10) Pub. No.: US 2026/0188935 A1
(43) Pub. Date: Jul. 2, 2026

(54) TERMINAL AND CONNECTOR

(71) Applicant: SUMITOMO WIRING SYSTEMS, LTD., Mie (JP)

(72) Inventor: Shunsuke TANIMURA, Mie (JP)

(21) Appl. No.: 18/729,882

(22) PCT Filed: Jan. 10, 2023
(86) PCT No.: PCT/JP2023/000280

§ 371 Date: Jul. 17, 2024

(30) Foreign Application Priority Data
Jan. 24, 2022 (JP) 2022-008422

(51) Int. Cl. H01R 13/436

(52) U.S. Cl. CPC H01R 13/4368

(57) ABSTRACT

A terminal 50 that is inserted into a sealing hole 41 of a mat seal 40 of a housing 10 from a rear side to a front side, and that is detached from the front side to the rear side includes a first box portion 54 that is substantially box-shaped, the first box portion 54 includes a first bottom wall 57, a pair of first side walls 58 that stand upright from two ends of the first bottom wall 57, a first ceiling wall 59 that opposes the first bottom wall 57, and a locking wall 61 positioned on a rear end side, which is a leading end side in a detaching direction, and the first ceiling wall 59 and the locking wall 61 are connected to each other via a connection portion 60 curved from the detaching direction toward the first bottom wall 57.

### TECHNICAL FIELD

The present disclosure relates to a terminal and a connector.

### BACKGROUND

There are known terminals that are unlikely to damage mat seals when inserted (into sealing holes of the mat seals) (JP 2016-001579 A). A lance engaging portion and a locking portion of such a terminal that have inclined portions are formed by bending a metal plate such that a fracture cross-section of the metal plate does not come into contact with the mat seal. In addition, when the terminal is pulled out and detached from the mat seal, the inclined portion of the locking portion comes into contact with the mat seal, and thus it is possible to suppress damage to the mat seal.

### PRIOR ART DOCUMENT

### Patent Document

Patent Document 1: JP 2016-001579 A

### SUMMARY OF THE INVENTION

### Problems to be Solved

With the above configuration, the lance engaging portion and the locking portion shaped as protrusions are formed by bending a metal plate in a complicated manner. For this reason, there is a risk that man-hours required for forming the terminal will increase, and cost of a primary material and processing will increase.

The present disclosure has been completed based on the above circumstances, and an object of the present disclosure is to provide a technique for suppressing damage to a mat seal when a terminal is detached, with a simple structure.

### Means to Solve the Problem

The present disclosure is directed to a terminal that is inserted into a sealing hole of a mat seal of a housing from a rear side to a front side, and that is detached from the front side to the rear side, and includes a first box portion that is substantially box-shaped, the first box portion includes: a first bottom wall, a pair of first side walls that stand upright from two ends of the first bottom wall, a first ceiling wall that opposes the first bottom wall, and a locking wall positioned on a rear end side of the first box portion, which is a leading end side in a detaching direction of the terminal, and the first ceiling wall and the locking wall are connected to each other via a connection portion curved from the detaching direction toward the first bottom wall.

### Effect of the Invention

According to the present disclosure, it is possible to suppress damage to a mat seal when a terminal is detached.

### BRIEF DESCRIPTION OF THE DRAWINGS

FIG. 1 is an exploded perspective view of a female connector that includes a terminal according to a first embodiment.

FIG. 2 is a side cross-sectional view showing a state where the terminal is held at a proper position.

FIG. 3 is a perspective view of the terminal as viewed obliquely from the upper rear side.

FIG. 4 is a partial enlarged view of FIG. 3.

FIG. 5 is a partial enlarged view of FIG. 2.

FIG. 6 is a side cross-sectional view showing the terminal in a state of abutting on a sealing hole in a detaching process.

FIG. 7 is a perspective view showing a terminal having a conventional shape.

FIG. 8 is a side cross-sectional view showing a terminal having a conventional shape in a state of abutting on a sealing hole in a process in which the terminal is detached.

### DETAILED DESCRIPTION TO EXECUTE THE INVENTION

### Description of Embodiments of the Disclosure

First, embodiments of the present disclosure will be listed and described.

(1) The present disclosure is directed to a terminal that is inserted into a sealing hole of a mat seal of a housing from a rear side to a front side, and that is detached from the front side to the rear side, and includes a first box portion that is substantially box-shaped, the first box portion includes: a first bottom wall, a pair of first side walls that stand upright from two ends of the first bottom wall, a first ceiling wall that opposes the first bottom wall, and a locking wall positioned on a rear end side of the first box portion, which is a leading end side in a detaching direction of the terminal, and the first ceiling wall and the locking wall are connected to each other via a connection portion curved from the detaching direction toward the first bottom wall.

When the terminal is detached from the housing, the connection portion curved from the detaching direction toward the first bottom wall comes into contact with the sealing hole, before a fracture cross-section of the terminal does. The sealing hole is enlarged by the connection portion, and thus, for example, it is possible to avoid contact between the mat seal and the fracture cross-section that is formed on a rear end of the first box portion, and to suppress damage to the mat seal.

When a load in the detaching direction is applied to the terminal, a plate surface of the locking wall can receive the load. Accordingly, the load is distributed over the entire plate surface, making it possible to suppress deformation of the terminal.

(2) Desirably, at least one of the first side walls has an extended portion extending to the rear side, and an extending end of the extended portion overlaps a plate surface of the locking wall as viewed from a direction perpendicular to the detaching direction.

In addition to the locking wall, the extending end can also receive the load in the detaching direction. Accordingly, the load is further distributed, making it possible to suppress deformation of the terminal.

(3) Desirably, the terminal includes a second box portion that is disposed on the front side relative to the first box portion with a space therebetween, and is substantially box-shaped, the second box portion includes: a second bottom wall, a pair of second side walls that stand upright from two ends of the second bottom wall, and a second ceiling wall that opposes the second bottom wall, and a distance between the second bottom wall and the second ceiling wall is shorter than or equal to a distance between the first bottom wall and the first ceiling wall.

The second box portion passes through the sealing hole enlarged by the first box portion. The height of the second box portion is smaller than the height of the first box portion, and thus the second box portion is unlikely to be caught on the sealing hole, making it possible to easily detach the terminal from the housing. A load that acts on the terminal is reduced when the terminal is detached, thus making it possible to suppress deformation of the second box portion.

(4) A connector according to the present disclosure includes the terminal according to the present disclosure, and a housing that includes a cavity that stores the terminal.

With this configuration, the connector according to the present disclosure can exert actions and effects that is equivalent to the actions and effects of the terminal according to any one of the above (1) to (3).

### Detailed Embodiments of Present Disclosure

Embodiments of the present disclosure will be described below. Note that the present disclosure is not limited to these examples, but rather is indicated by the claims, and is intended to include all modifications that are within the meanings and the scope that are equivalent to those of the claims.

### First Embodiment

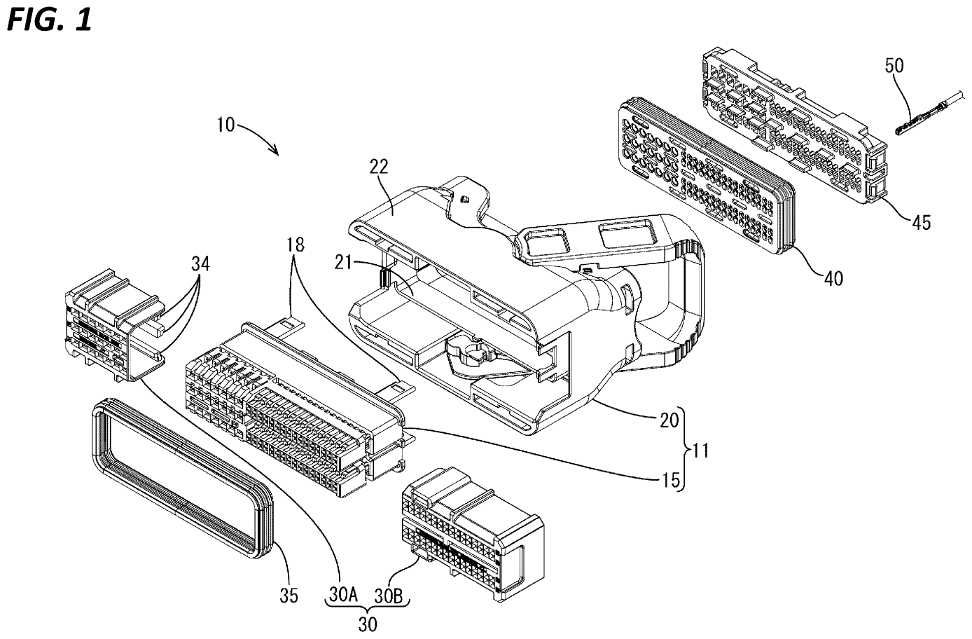

A first embodiment of the present disclosure will be described with reference to FIGS. 1 to 8.

### [Overall Configuration of Connector]

As shown in FIG. 1, a connector according to the present embodiment is configured by attaching a plurality of terminals 50 to a housing 10. Note that the number of terminals 50 illustrated in FIG. 1 is one. The housing 10 is configured by attaching a housing body 11, a retainer 30, a seal ring 35, a mat seal 40, and a mat seal holder 45. The housing body 11 is configured by attaching an inner housing 15 and an outer housing 20 to each other.

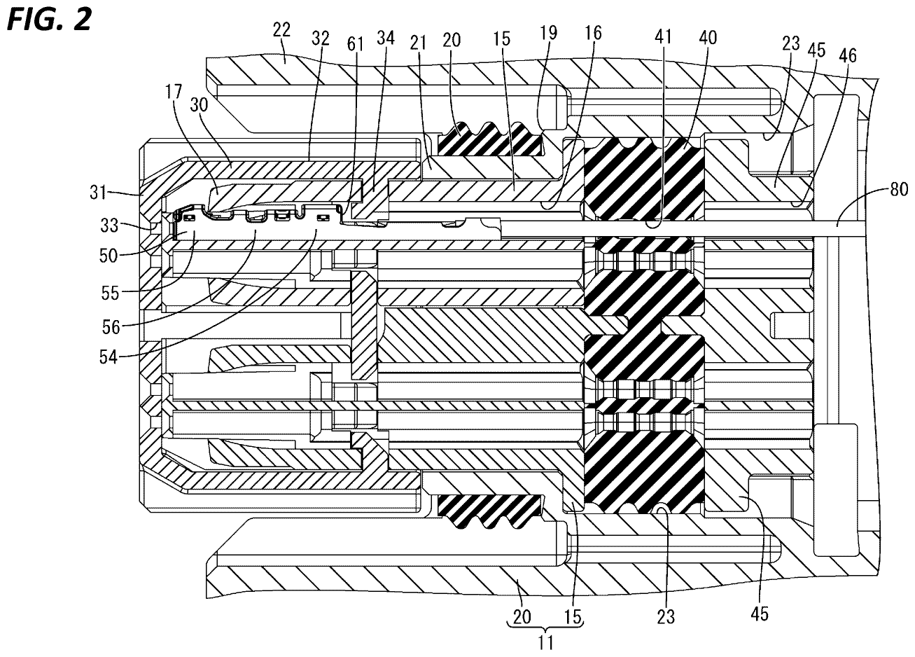

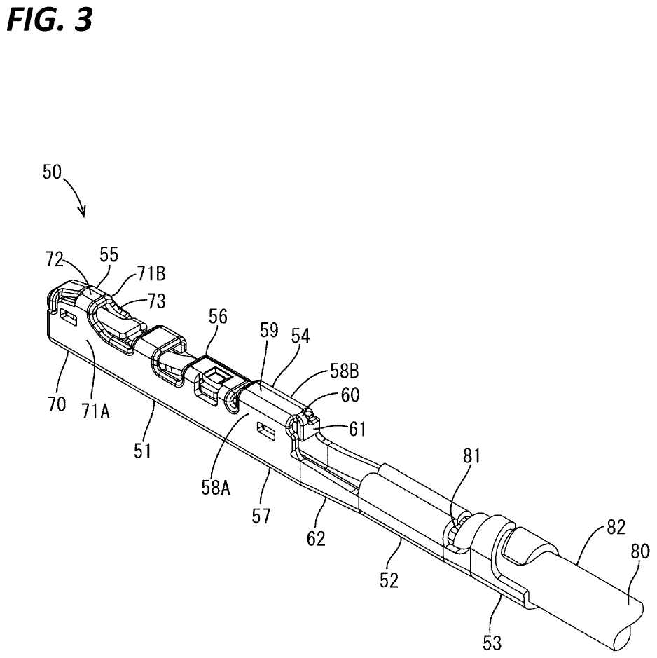

In the following description, in the front-rear direction, a side on which the connector is fitted with a partner connector is the front side. Specifically, the obliquely lower left side (closer side) in FIG. 1 and the left side in FIGS. 2 and 3 are defined as the front side. The up-down direction in FIGS. 1 to 3, with the upper side and the lower side, is the up-down direction as is. The front side corresponds to a direction in which the terminal 50 is inserted into the housing 10. In addition, the rear side (an example of a detaching direction) is a direction in which the terminal 50 is detached from the housing 10.

The outer housing 20 is made of a synthetic resin. The outer housing 20 includes a terminal storage portion 21 and a tubular fitting portion 22. The tubular fitting portion 22 protrudes forward from the outer peripheral rear end portion of the terminal storage portion 21 so as to surround the terminal storage portion 21.

The inner housing 15 is made of a synthetic resin, and is shaped as a substantially rectangular block as a whole. The inner housing 15 includes four engaging portions 18 that extend rearward from the rear end surface. The housing body 11 is formed by bringing the inner housing 15 close to the outer housing 20 from the front, and engaging the engaging portions 18 with engagement portions (not illustrated) provided in the outer wall of the terminal storage portion 21.

As shown in FIG. 2, a plurality of cavities 16 pass through the inner housing 15 in the front-rear direction. Lances 17 that protrude forward in a cantilever fashion are respectively provided on inner surfaces of the cavities 16. A terminal 50 connected to an end portion of a cable 80 is inserted into one of the cavities 16 from the rear side. The terminal 50 is elastically locked on the lance 17, and is retained in a state of being stored in the cavity 16.

As shown in FIG. 1, the retainer 30 is composed of a right retainer piece 30A and a left retainer piece 30B that are separated as two right and left pieces, and are made of a synthetic resin. The retainer 30 in an attached state is shaped as a cap that is open rearward. The retainer 30 includes a front surface wall 31 shaped as a substantially rectangular flat surface, and a peripheral surface wall 32 that protrudes rearward from the peripheral edge of the front surface wall 31. A plurality of insertion holes 33 into which tabs of male terminals (not illustrated) mounted to a partner connector can be inserted are provided in the front surface wall 31. The insertion holes 33 are provided at positions respectively corresponding to the cavities 16, as viewed from the front-rear direction.

The right retainer piece 30A and the left retainer piece 30B include restricting portions 34 extending in the left-right direction. When the retainers 30A and 30B are properly mounted to the housing body 11 from the right and the left, the front surface wall 31 faces the front surface of the housing body 11, and the peripheral surface wall 32 is disposed to cover the outer peripheral surface of the inner housing 15. The restricting portions 34 are inserted to the rear side of later-described first box portions 54 of the terminals 50 from the left-right direction. Accordingly, the front surfaces of the restricting portions 34 are disposed at positions opposing later-described locking walls 61 of the terminals 50, and restrict rearward (detaching direction) displacement of the terminals 50.

The seal ring 35 is made of rubber. As shown in FIG. 1, the seal ring 35 has a substantially rectangular annular shape, is fitted with and is held by the outer peripheral surface of the inner housing 15. As shown in FIG. 2, the seal ring 35 abuts on a step surface 19 provided on the outer peripheral surface of the inner housing 15 from the front side. When the connector is fitted with a partner connector (not illustrated), the seal ring 35 is elastically sandwiched between a hood portion of the partner connector and the inner housing 15, and the two connectors are sealed in a liquid-tight manner.

As shown in FIG. 2, a recessed storage portion 23 is provided in the rear surface of the outer housing 20. The terminal storage portion 21 and the recessed storage portion 23 are defined by a rear end portion of the terminal storage portion 21.

The mat seal 40 is made of rubber, and has a cross section shaped as a substantially rectangular plate as shown in FIG. 1, and extends in a direction at a substantially right angle with respect to the front-rear direction. The mat seal 40 is inserted into the recessed storage portion 23 from the rear side, the front surface of the mat seal 40 faces and elastically comes into intimate contact with the rear surface of the inner housing 15 as shown in FIG. 2, and the outer peripheral surface of the mat seal 40 faces and elastically comes into intimate contact with the inner periphery surface of the recessed storage portion 23.

Substantially circular sealing holes 41 pass through the mat seal 40 in the front-rear direction, at positions respectively corresponding to the cavities 16. A terminal 50 and the cable 80 connected to the terminal 50 are inserted into each of the sealing holes 41 from the rear side. After the terminal 50 passes through the sealing hole 41, the periphery of the cable 80 is sealed in a liquid-tight manner.

The mat seal holder 45 is made of a synthetic resin, and is shaped as a plate that has a substantially rectangular cross section as shown in FIG. 1. The mat seal holder 45 includes holder holes 46 that are open at positions respectively corresponding to the sealing holes 41. When a terminal 50 is inserted into a cavity 16, the terminal 50 is moved from the holder hole 46, passes through the sealing hole 41, and reaches the cavity 16. When the terminal 50 is detached from the cavity 16, the terminal 50 is moved from the cavity 16, passes through the sealing hole 41, and passes through the holder hole 46.

### [Terminal]

Each terminal 50 is formed by press-cutting an electrically conductive metal plate into a predetermined shape, bending the press-cut plate, and the like. The terminal 50 according to the present embodiment is a female terminal, and has a shape elongated in the front-rear direction. As shown in FIG. 3, the terminal 50 includes a body portion 51 on the front side thereof, and a wire barrel portion 52 and an insulation barrel portion 53 on the rear side thereof.

The insulation barrel portion 53 is disposed on the rear side relative to the wire barrel portion 52. The wire barrel portion 52 is pressure-bonded and connected to a conductor 81 (such as a twisted wire) exposed as a result of removing a coating 82 at the front end portion of the cable 80. The insulation barrel portion 53 is pressure-bonded and connected to the coating 82 at a front end portion of the cable 80 (the coating 82 positioned on the rear side of the conductor 81 that is exposed).

As shown in FIG. 3, the body portion 51 includes a first box portion 54 positioned at the rear end of the body portion 51, a second box portion 55 positioned at the front end of the body portion 51, and an intermediate portion 56 positioned between the first box portion 54 and the second box portion 55.

### [First Box Portion]

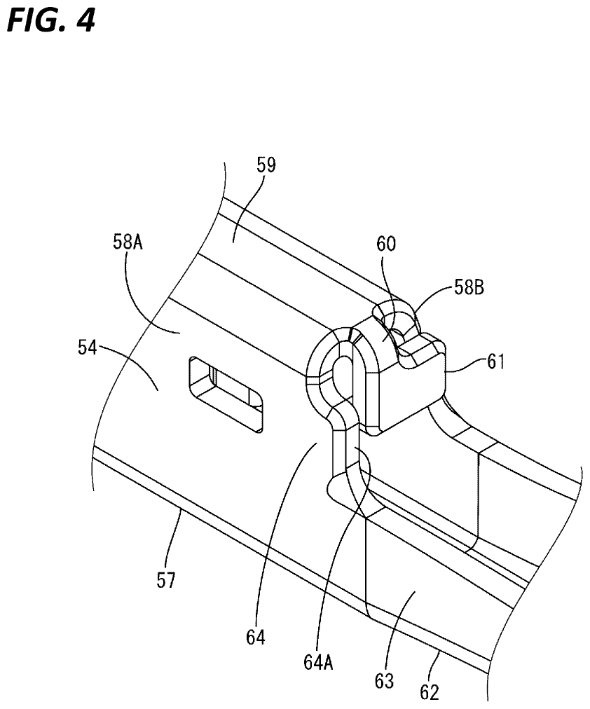

As shown in FIGS. 3 and 4, the first box portion 54 includes a first bottom wall 57 positioned on the lower side, a pair of first side walls 58A and 58B, a first ceiling wall 59 positioned on the upper side, a connection portion 60 that extends downward from the rear side, with the rear end of the first ceiling wall 59 serving as a start point, and the locking wall 61 connected to the leading end of the connection portion 60. In the following description, the first side walls 58A and 58B are collectively referred to as “first side walls 58”.

The first bottom wall 57 is a portion of the lower wall of the body portion 51, and extends in the front-rear direction and the left-right direction (width direction). The first bottom wall 57 is connected to the wire barrel portion 52 via a connection portion 62.

The first side walls 58 stand upright from the two right and left ends of the first bottom wall 57. As viewed from the rear side, the left wall is defined as the first side wall 58A, and the right wall is defined as the first side wall 58B. The first side walls 58 extends in the up-down direction, and are connected to side portions 63 of the connection portion 62, at the rear end side thereof on the lower side (see FIG. 4).

The first ceiling wall 59 extends from one of the first side walls 58, namely the first side wall 58A to the other of the first side walls 58, namely the first side wall 58B, and forms an upper wall of the first box portion 54. The first ceiling wall 59 is disposed parallel to the first bottom wall 57, with a space between the first ceiling wall 59 and the first bottom wall 57. The end portion on the right side of the first ceiling wall 59 is curved to the lower side on which the first side wall 58B is positioned.

The belt-shaped connection portion 60 that extends from the rear end of the first ceiling wall 59 rearward on the base end side is provided. The connection portion 60 is smoothly curved downward as separating away from the rear end of the first ceiling wall 59, and the leading end of the connection portion 60 changes its orientation by 90 degrees with respect to the base end thereof, and faces downward. The connection portion 60 is connected to about a center of the rear end of the first ceiling wall 59. The width in the left-right direction of the connection portion 60 is smaller than the width of the first ceiling wall 59.

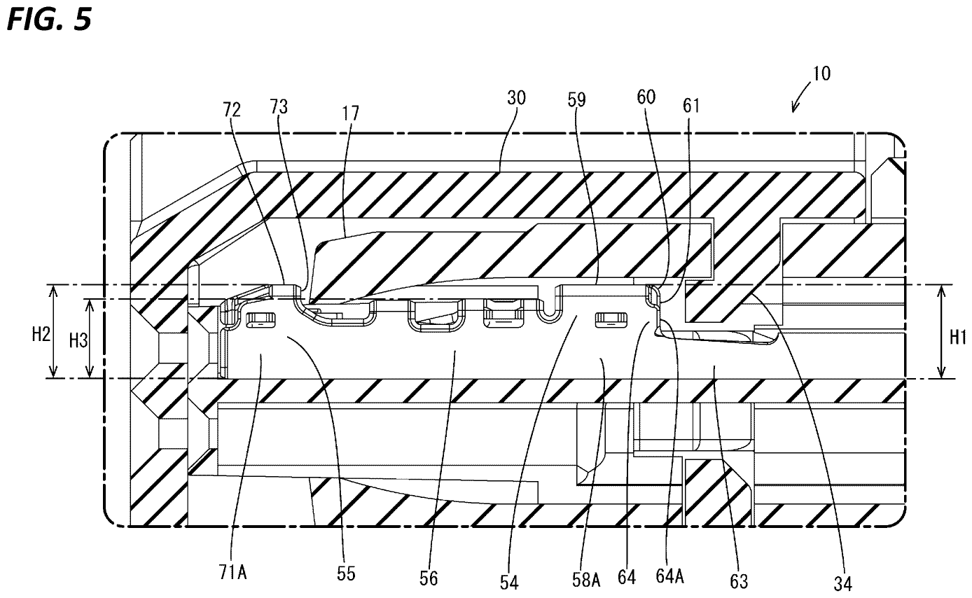

The locking wall 61 shaped as a rectangular plate and elongated in the left-right direction is connected to the leading end of the connection portion 60. As shown in FIG. 5, the plate surface of the locking wall 61 is a flat surface extending in a direction substantially perpendicular to the front-rear direction. The locking wall 61 blocks, from the rear side, a tubular upper half portion surrounded by the first bottom wall 57, the first side walls 58, and the first ceiling wall 59.

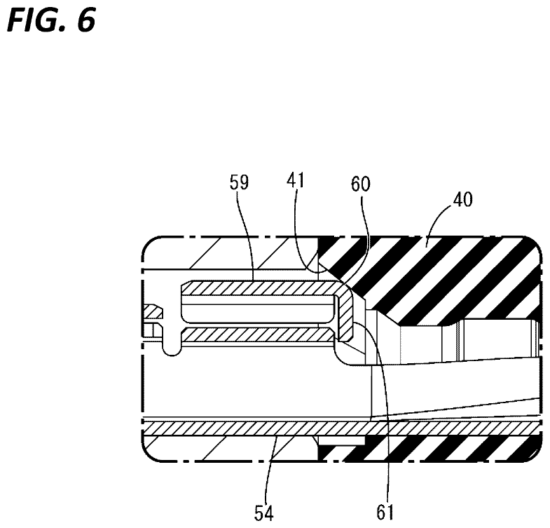

With such a configuration, when the terminal 50 is detached (pulled out) from the housing 10 rearward, the connection portion 60 first comes into contact with the inner periphery surface of the sealing hole 41 as shown in FIG. 6. Since the connection portion 60 is smoothly curved downward from the rear side, and thus the terminal 50 is unlikely to be caught on the sealing hole 41, and is unlikely to damage the inner peripheral surface of the sealing hole 41. The sealing hole 41 is enlarged by the connection portion 60. Accordingly, when the terminal 50 is detached, for example, it is possible to avoid contact between the mat seal 40 and a fracture cross-section formed on a rear end corner portion of the first box portion 54, and to suppress damage to the sealing hole 41 caused by the terminal 50.

In addition, as shown in FIG. 5, the terminal 50 is retained by the restricting portion 34 of the retainer 30. When external force in the detaching direction is applied to the terminal 50, the plate surface of the locking wall 61 abuts on the front surface of the restricting portion 34, thereby restricting displacement of the terminal 50. The load is distributed by the flat surface (plate surface of the locking wall 61) receiving external force instead of an end surface of the metal plate, and it is possible to suppress deformation of the terminal 50.

As shown in FIGS. 4 and 5, one of the first side walls 58 (in the present embodiment, the first side wall 58A) includes an extended portion 64 extending rearward, on the rear end side thereof. The extended portion 64 is positioned at a position lower than the boundary between the first ceiling wall 59 and the first side wall 58A and higher than the side portion 63. A rear end edge (an example of an extending end) 64A of the extended portion 64 extends in the up-down direction. As shown in FIG. 5, the length in the front-rear direction of the extended portion 64 is set such that the rear end edge 64A overlaps the plate surface of the locking wall 61 as viewed from the left-right direction.

The rear end edge 64A of the extended portion 64 overlaps the plate surface of the locking wall 61 as viewed from the left-right direction. Therefore, when external force in the detaching direction acts on the terminal 50, the rear end edge 64A, in addition to the plate surface of the locking wall 61, abuts on the front surface of the restricting portion 34. Accordingly, the load is further distributed, making it possible to suppress deformation of the terminal 50.

### [Second Box Portion]

As shown in FIG. 3, the second box portion 55 is disposed on the front side, with a space between the second box portion 55 and the first box portion 54, and the intermediate portion 56 is disposed between the first box portion 54 and the second box portion 55. The second box portion 55 includes a second bottom wall 70 positioned on the lower side, a pair of second side walls 71A and 71B, and a second ceiling wall 72 positioned on the upper side. In the following description, the second side walls 71A and 71B are collectively referred to as “second side walls 71”. The second box portion 55 according to the present embodiment is open in the front-rear direction. A tab of a partner terminal (male terminal) can be inserted into and electrically connected to the second box portion 55 from an upper opening.

The second bottom wall 70 is a portion of the lower wall of the body portion 51 as with the first bottom wall 57, and extends in the front-rear direction and the left-right direction (width direction). The second side walls 71 stand upright from the two right and left ends of the second bottom wall 70, and extends in the up-down direction.

The second ceiling wall 72 extends from one of the second side walls 71, namely the second side wall 71A to the other of the second side walls 71, namely the second side wall 71B, and forms an upper wall of the second box portion 55. The second ceiling wall 72 is disposed with a space between the second ceiling wall 72 and the second bottom wall 70, and the front side of the second ceiling wall 72 is inclined downward toward the front side. A rear end of the second ceiling wall 72 is a notch portion 73 notched from the upper side to the lower side so as to form a recess. As shown in FIG. 5, in the housing 10, an end surface of the notch portion 73 and the lance 17 are engaged with each other. Accordingly, the terminal 50 is elastically locked with the lance 17, and is retained in the cavity 16.

As shown in FIG. 5, the maximum value of the distance between the lower wall (the first bottom wall 57) of the body portion 51 and the first ceiling wall 59 is defined as a height H1 of the first box portion 54. The maximum value of the distance between the lower wall (the second bottom wall 70) of the body portion 51 and the second ceiling wall 72 is defined as a height H2 of the second box portion 55. Note that a height H3 of the intermediate portion 56 is smaller than or equal to the height H1.

The lengths in the up-down direction of the first side walls 58 and the second side walls 71 of the terminal 50 according to the present embodiment are set such that the height H2 of the second box portion 55 is smaller than or equal to the height H1 of the first box portion 54. When the terminal 50 is detached from the housing 10, the first box portion 54 (the height H1) first passes through the sealing hole 41. Next, the intermediate portion 56 (the height H3) and the second box portion 55 (the height H2) sequentially pass through the sealing hole 41.

The first box portion 54, which passes through the sealing hole 41 first, passes through the sealing hole 41 while expanding the sealing hole 41. The intermediate portion 56 and the second box portion 55 pass through the sealing hole 41 enlarged by the first box portion 54 having the height H1. Both the heights H2 and H3 are smaller than or equal to H1, and thus the intermediate portion 56 and the second box portion 55 are unlikely to be caught on the sealing hole 41, and the terminal 50 can be easily pulled out. In addition, a load that acts on the second box portion 55 reduces in a pulling-out process, thus making it possible to suppress deformation of the second box portion 55.

### Actions and Effects of Embodiments

The terminal 50 is formed by press-cutting a metal plate, bending the press-cut plate, and the like. There are minute burr and unevenness on a fracture cross-section formed as a result of the press-cutting process. When the terminal 50 is pulled out from the housing 10, and burr or the like is caught on the inner periphery surface of the sealing hole 41, the mat seal 40 is damaged.

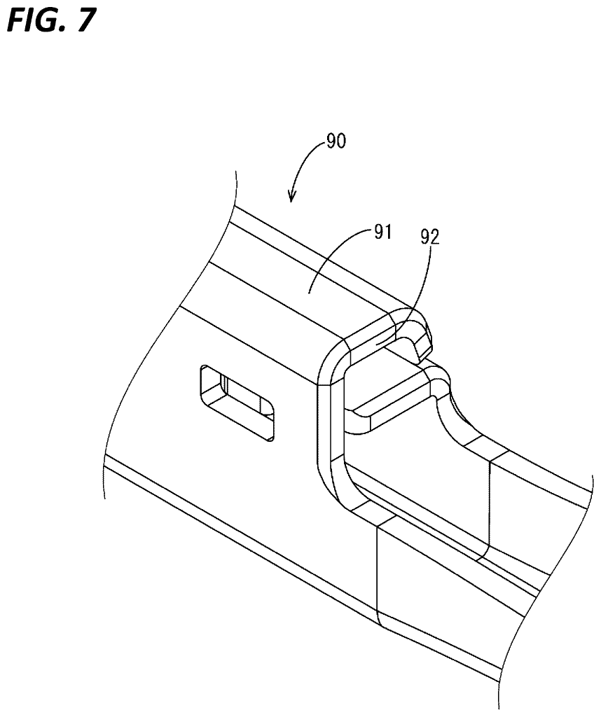

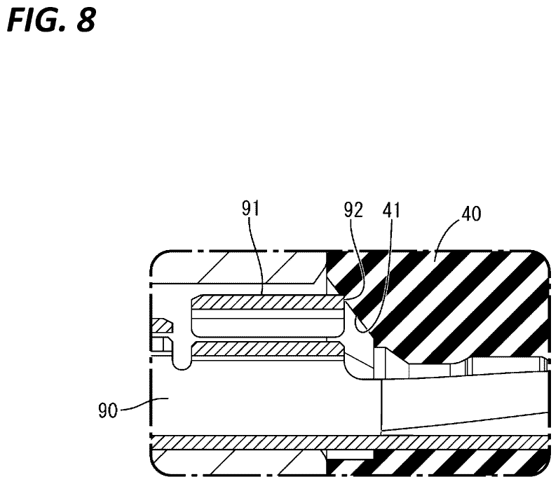

FIGS. 7 and 8 show a terminal 90 having a configuration in which the connection portion 60 and the locking wall 61 are removed from the terminal 50 according to the present embodiment. When the terminal 90 is pulled out rearward, an end surface 92 on the rear side of a first box portion 91 comes into contact with the sealing hole 41. The end surface 92 is a fracture cross-section formed when the metal plate is press-cut. The end surface 92 of the terminal 90 that does not include the connection portion 60 and the locking wall 61 is likely to be caught on the sealing hole 41 when the end surface 92 enlarges the sealing hole 41, and there is a risk that the mat seal 40 will be damaged.

The terminal 50 according to the present embodiment is the terminal 50 that is inserted into the sealing hole 41 of the mat seal 40 of the housing 10 from the rear side to the front side, and that is detached from the front side to the rear side, and includes the first box portion 54 that is substantially box-shaped, the first box portion 54 includes: the first bottom wall 57, the pair of first side walls 58 that stand upright from the two end portions of the first bottom wall 57, the first ceiling wall 59 that opposes the first bottom wall 57, and the locking wall 61 positioned on the rear end side, and the first ceiling wall 59 and the locking wall 61 are connected to each other via the connection portion 60 curved from the rear side toward the first bottom wall 57.

According to the above configuration, when the terminal 50 inserted into the mat seal 40 is detached, the connection portion 60 that connects the first ceiling wall 59 of the first box portion 54 of the terminal 50, which is an upper surface, and the locking wall 61, which is a rear surface, comes into contact with the sealing hole 41 first (see FIG. 6). Since the curved connection portion 60 comes into contact with the inner periphery surface of the sealing hole 41, and enlarges the sealing hole 41, the terminal 50 is unlikely to be caught on the sealing hole 41. Accordingly, it is possible to suppress damage to the mat seal 40 when the terminal 50 is detached and deformation of the terminal 50 due to an excessive load being applied.

In addition, when external force in the detaching direction is applied to the terminal 50, displacement of the terminal 50 is restricted due to the plate surface of the locking wall 61 and the restricting portion 34 abutting on each other. By the plate surface of the locking wall 61 receiving external force, the load is distributed, making it possible to suppress deformation of the terminal 50.

At least one of the first side walls 58, namely the first side wall 58A of the terminal 50 of the present embodiment includes the extended portion 64 that extends rearward, and the rear end edge 64A of the extended portion 64 overlaps the plate surface of the locking wall 61 as viewed from the left-right direction.

With the above configuration, when external force in the detaching direction is applied to the terminal 50, the rear end edge 64A, in addition to the plate surface of the locking wall 61, can abut on the restricting portion 34 and receive the load. Accordingly, the load is further distributed, making it possible to suppress deformation of the terminal 50.

The terminal 50 according to the present embodiment includes the second box portion 55 that is substantially box-shaped and is disposed on the front side relative to the first box portion 54 with a space therebetween, the second box portion 55 includes the second bottom wall 70, the pair of second side walls 71 that stand upright from the two ends of the second bottom wall 70, and the second ceiling wall 72 that opposes the second bottom wall 70, and the distance between the second bottom wall 70 and the second ceiling wall 72 is smaller than or equal to the distance between the first bottom wall 57 and the first ceiling wall 59.

With the above configuration, first, the first box portion 54 (the height H1) passes through the sealing hole 41 while enlarging the sealing hole 41. After that, the second box portion 55 whose height (the height H2) is smaller than that of the first box portion 54 can easily pass through the enlarged sealing hole 41. Accordingly, the second box portion 55 is unlikely to be caught on the sealing hole 41, and the terminal 50 can be easily detached. In addition, in a process of pulling out the terminal 50, the load that acts on the second box portion 55 decreases, thus making it possible to suppress deformation of the second box portion 55.

### Other Embodiment

(1) In the above embodiment, a case has been illustrated in which the first side wall 58A includes the extended portion 64, but a configuration may also be adopted in which the first side wall 58B includes the extended portion 64. In addition, both the first side walls 58A and 58B may include the extended portion 64.

(2) In the above embodiment, a case has been illustrated in which the first side wall 58A includes the extended portion 64, but a configuration may also be adopted in which neither the first side wall 58A nor the first side wall 58B includes the extended portion 64.

(3) In the above embodiment, the terminal 50 that includes the second box portion 55 has been illustrated, but a configuration may also be adopted in which the terminal 50 does not include the second box portion 55.

(4) In the above embodiment, a case has been illustrated in which the second box portion 55 has a shape that is open forward, and the terminal 50 is a female terminal. The terminal 50 is not limited to a female terminal, and may be a male terminal that has a tab extending forward in place of the second box portion 55.

### LIST OF REFERENCE NUMERALS

10 Housing
11 Housing body
12 Wire barrel portion
15 Inner housing
16 Cavity
17 Lance
18 Engaging portion
19 Step surface
20 Outer housing
21 Terminal storage portion
22 Tubular fitting portion
23 Recessed storage portion
30 Retainer
30A Right retainer piece
30B Left retainer piece
31 Front surface wall
32 Peripheral surface wall
33 Insertion hole
34 Restricting portion
35 Seal ring
40 Mat seal
41 Sealing hole
45 Mat seal holder
46 Holder hole
50 Terminal
51 Body portion
52 Wire barrel portion
53 Insulation barrel portion
54 First box portion
55 Second box portion
56 Intermediate portion
57 First bottom wall
58, 58A, 58B First side wall
59 First ceiling wall
60 Connection portion
61 Locking wall
62 Connection portion
63 Side portion
64 Extended portion
64A Rear end edge
70 Second bottom wall
71, 71A, 71B Second side wall
72 Second ceiling wall
73 Notch portion
80 Cable
81 Conductor
82 Coating
90 Terminal
91 First box portion
92 End surface

1. A terminal that is inserted into a sealing hole of a mat seal of a housing from a rear side to a front side, and that is detached from the front side to the rear side, the terminal comprising:
a first box portion that is substantially box-shaped,
wherein the first box portion includes: a first bottom wall, a pair of first side walls that stand upright from two ends of the first bottom wall, a first ceiling wall that opposes the first bottom wall, and a locking wall positioned on a rear end side of the first box portion, which is a leading end side in a detaching direction of the terminal,
the first ceiling wall and the locking wall are connected to each other via a connection portion curved from the detaching direction toward the first bottom wall,
one of the first side walls has an extended portion extending to the rear side,
an extending end of the extended portion overlaps a plate surface of the locking wall as viewed from a direction perpendicular to the detaching direction, and
the locking wall extends from a portion thereof that is coupled to the connection portion to the other first side wall side, and an extended end portion of the locking wall and a rear end edge of the other first side wall oppose each other in a front-rear direction.

2. (canceled)

3. The terminal according to claim 1, further comprising
a second box portion that is disposed on the front side relative to the first box portion with a space therebetween, and is substantially box-shaped,
wherein the second box portion includes: a second bottom wall, a pair of second side walls that stand upright from two ends of the second bottom wall, and a second ceiling wall that opposes the second bottom wall, and
a distance between the second bottom wall and the second ceiling wall is shorter than or equal to a distance between the first bottom wall and the first ceiling wall.

4. A connector comprising:
the terminal according to claim 1, and
a housing that includes a cavity that stores the terminal.
